(19) United States
(12) Patent Application Publication
(10) Pub. No.: US 2008/0024441 A1
(43) Pub. Date: Jan. 31, 2008

(54) Displacement type pointing device and method

(76) Inventors: Jonah Harley, Mountain View, CA (US); Todd Sachs, Palo Alto, CA (US)

Correspondence Address: Kathy Manke;Avago Technologies Limited, 4380 Ziegler Road, Fort Collins, CO, 80525, US

(21) Appl. No.: 11/492,633

(22) Filed: Jul. 25, 2006

(51) Int. Cl. G09G 5/08

(52) U.S. Cl. 345/157

(57) ABSTRACT

A pointing device includes a displaceable member, a sense system, and a processing system. The displaceable member is movable in an operational zone. The sense system is operable to generate sense signals in response to a touching of the displaceable member by a user's finger and in response to different positions of the displaceable member in the operational zone. The processing system is operable to determine from the sense signals in-contact periods during which the displaceable member is in contact with the user's finger. Each of the in-contact periods has an initialization phase followed by a motion tracking phase. For each of the in-contact periods the processing system is operable to: (i) during the initialization phase, determine from the sense signals a respective current origin position in the operational zone; and (ii) during the motion tracking phase, determine from the sense signals positions of the displaceable member in relation to the current origin position.

### CROSS-REFERENCE TO RELATED APPLICATIONS

This application relates to copending U.S. patent application No. 10/723,957, filed Nov. 24, 2004, by Jonah Harley et al. and entitled “Compact Pointing Device,” which is incorporated herein by reference.

### BACKGROUND

Many different types of pointing devices have been developed for inputting commands into a machine. For example, hand-manipulated pointing devices, such as computer mice, joysticks, trackballs, touchpads, and keyboards, commonly are used to input instructions into a computer by manipulating the pointing device. Such pointing devices allow a user to control movement of a cursor (i.e., a virtual pointer) across a computer screen, select or move an icon or other virtual object displayed on the computer screen, and open and close menu items corresponding to different input commands.

Pointing devices have been developed for large electronic devices, such as desktop computers, which are intended to remain stationary, and for small portable electronic devices, such as cellular telephones and mobile computer systems. Pointing devices for large electronic devices typically have fewer and more flexible design constraints than pointing devices for portable electronic devices because of the greater space and power resources that are available. In general, a pointing device for use in portable electronic devices should allow a user to move a cursor quickly and accurately, operate in an intuitive fashion, and operate within limited workspace and power constraints.

Displacement type pointing devices have been developed to meet the constraints inherent in portable electronic devices. These types of pointing devices include a displaceable member (e.g., a puck, button, or other movable body) that moves in a defined field of motion upon application of force by, for example, a user's finger. When the user releases the displaceable member, a restoring mechanism (e.g., a set of springs) typically returns the displaceable member to a central location within the field of motion. A position sensor determines the displacement of the displaceable member within the field of motion and typically maps the displacement of the displaceable member to the velocity of the cursor. The cursor processing system typically fixes the position of the cursor on the display after the restoring mechanism has returned the displaceable member to the central location within the field of motion.

Ideally, when the user is not touching the displaceable member, the springs should return the displaceable member to the same central “origin” position within the field of motion. In this case, only the origin position could be mapped to zero cursor velocity and the cursor would move only when the displaceable member is being manipulated by the user. In practice, however, there typically are electronic and mechanical offsets that prevent the position sensor from reading exactly zero displacement from the origin position even when the displaceable member is at the origin position. To avoid unwanted cursor drift, many displacement type pointing devices include a “dead zone” around the origin position. The position mapping system maps all positions within the dead zone to zero cursor velocity. Thus, in these pointing devices, the cursor is not moved on the display until after the displaceable member has been moved outside the dead zone.

Unfortunately, the use of a dead zone makes accurate control of the cursor difficult. For example, the presence of the dead zone prevents the cursor from responding immediately to displacement of the displaceable member. Consequently, users of these pointing devices typically apply a greater displacement to the displaceable member than needed to reach the desired target location on the display and, as a result, when the cursor finally responds to the applied displacement the cursor oftentimes overshoots the desired target location.

What are needed are displacement type pointing devices and methods that are capable of avoiding cursor drift due to imperfect re-centering of the displaceable member while substantially reducing the unintuitive and confusing effects associated with transitions of the displaceable member out of the dead zone.

### SUMMARY

In one aspect, the invention features a pointing device that includes a displaceable member, a sense system, and a processing system. The displaceable member is movable in an operational zone. The sense system is operable to generate sense signals in response to a touching of the displaceable member by a user's finger and in response to different positions of the displaceable member in the operational zone. The processing system is operable to determine from the sense signals in-contact periods during which the displaceable member is in contact with the user's finger. Each of the in-contact periods has an initialization phase followed by a motion tracking phase. For each of the in-contact periods the processing system is operable to: (i) during the initialization phase, determine from the sense signals a respective current origin position in the operational zone; and (ii) during the motion tracking phase, determine from the sense signals positions of the displaceable member in relation to the current origin position.

Other features and advantages of the invention will become apparent from the following description, including the drawings and the claims.

### DESCRIPTION OF DRAWINGS

FIG. 1 is a diagrammatic view of an embodiment of a pointing device, which includes a displaceable member, a sense system, and a processing system, in an exemplary operational environment.

FIG. 2A is a diagrammatic top view of an embodiment of the pointing device shown in FIG. 1.

FIG. 2B is a cross-sectional side view of the pointing device shown in FIG. 2A taken along the line 2B-2B.

FIG. 3 is a top view of an embodiment of the sense system shown in FIG. 1.

FIG. 4 is a diagram of an equivalent circuit of the displaceable member and the sense system shown in FIG. 3 electrically connected to the processing system shown in FIG. 1.

FIG. 5 is a flow diagram of an embodiment of a method that is executed by an embodiment of the pointing device of FIG. 1.

FIG. 6 is a flow diagram of an embodiment of a method that is executed by an embodiment of the pointing device of FIG. 1.

FIG. 7 is a diagrammatic top view of a embodiment of an operational zone of the pointing device of FIG. 1 depicting a specified central zone and a zero-cursor-velocity zone in accordance with an embodiment of the method of FIG. 6.

FIG. 8 is a graph of cursor velocity plotted as a function of displacement measure magnitude in accordance with an embodiment of the method of FIG. 6.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail below provide displacement type pointing devices and methods that are capable of avoiding cursor drift due to is imperfect re-centering of the displaceable member while substantially reducing the unintuitive and confusing effects that oftentimes are associated with transitions of the displaceable member out of the predefined dead zones in typical displacement-type devices.

### II. Overview

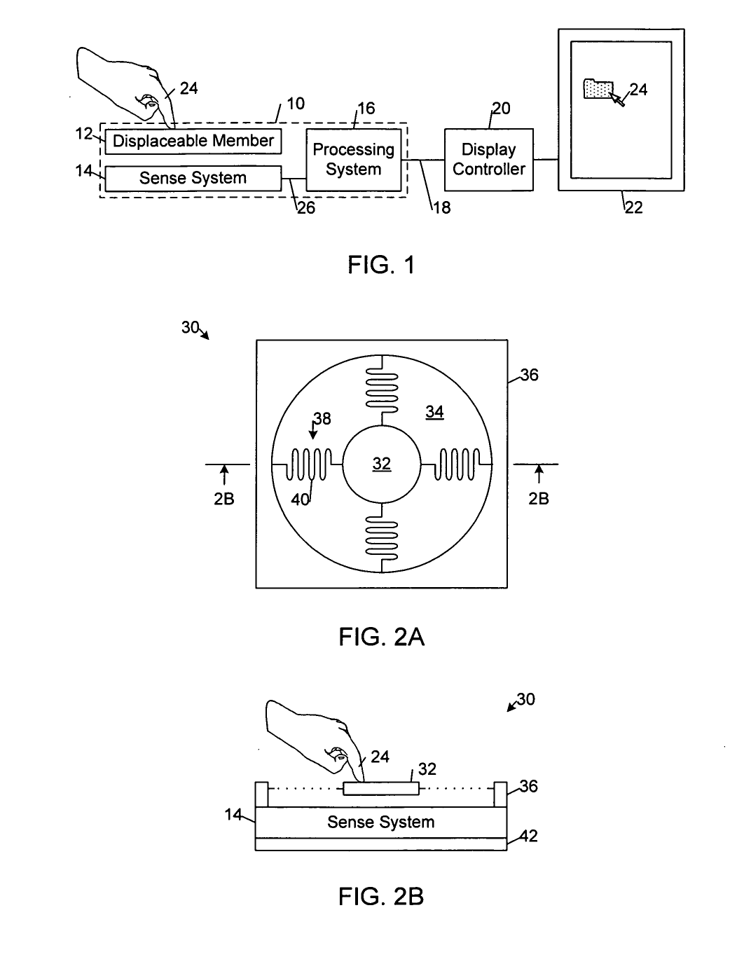

FIG. 1 shows an embodiment of a displacement type pointing device 10 that includes a displaceable member 12, a sense system 14, and a processing system 16. The pointing device 10 outputs display control signals 18 to a display controller 20, which drives a display 22.

The displaceable member 12 may be implemented by a puck, button, or other movable body. The displaceable member 12 is movable within a confined field of motion, which is referred to herein as the “operational zone.” In one exemplary mode of operation, a user's finger 24 manipulates the displaceable member 12 within the operational zone. The displaceable member typically is re-centered in the operational zone by a restoring mechanism when there is no external force applied to the displaceable member 12. The restoring mechanism may be implemented by one or more resilient structures (e.g., springs or elastomeric elements) that urge the displaceable member to a central region of the operational zone.

The sense system 14 generates sense signals 26 in response to a touching of the displaceable member 12 by the user's finger 24 and in response to different positions of the displaceable member 12 in the operational zone. For example, in some embodiments, the sense system 14 detects when the displaceable member 12 is being touched and detects the positions of the displaceable member within the operational zone. In some embodiments, the sense system 14 includes one or more of the following types of position sense mechanisms: an electrical sense mechanism (e.g., capacitive electrode or resistor circuit), a magnetic sense mechanism (e.g., Hall Effect sensor), or an optical sensor (e.g., a CMOS or CCD imaging array). The sense signals 26 that are generated by the sense system 14 either directly convey the position of the displaceable member 12 within the operational zone or convey information from which the position of the displaceable member 12 within the operational zone may be derived.

The processing system 16 translates the sense signals 26 into the display control signals 18. In this process, the processing system 16 determines from the sense signals 26 in-contact periods during which the displaceable member is in contact with the user's finger. Each of the in-contact periods has an initialization phase followed by a motion tracking phase. For each of the in-contact periods the processing system 16 is operable to (i) during the initialization phase, determine from the sense signals a respective current origin position in the operational zone, and (ii) during the motion tracking phase, determine from the sense signals positions of the displaceable member in relation to the current origin position. Examples of the types of display control signals 18 that may be produced by the processing system 14 include: position data (e.g., distance and direction in a coordinate system centered at the origin of the operational zone) that describe the position of the displaceable member 12 within the operational zone; cursor position and velocity data; and scrolling position and distance data. In general, the processing system 16 may be implemented by one or more discrete modules that are not limited to any particular hardware, firmware, or software configuration. The one or more modules may be implemented in any computing or data processing environment, including in digital electronic circuitry (e.g., an application-specific integrated circuit, such as a digital signal processor (DSP)) or in computer hardware, firmware, device driver, or software.

The display controller 20 processes the display control signals 18 to control the movement of the pointer 24 on the display 22. The display controller 20 typically executes a driver to process the display control signals 18. In general, the driver may be in any computing or processing environment, including in digital electronic circuitry or in computer hardware, firmware, or software. In some embodiments, the driver is a component of an operating system or an application program.

The display 22 may be, for example, a flat panel display, such as a LCD (liquid crystal display), a plasma display, an EL display (electro-luminescent display) and a FED (field emission display).

In some embodiments, the pointing device 10 and the display 22 are integrated into a single unitary device, such as a portable (e.g., handheld) electronic device. The portable electronic device may be any type of device that can be readily carried by a person, including a cellular telephone, a cordless telephone, a pager, a personal digital assistant (PDA), a digital audio player, a digital camera, and a digital video game console. In other embodiments, the pointing device 10 and the display 22 are implemented as separate discrete devices, such as a separate pointing device and a remote display-based system.

In general, the remote system may be any type of display-based appliance that receives user input, including a general-purpose computer system, a special-purpose computer system, and a video game system. The display control signals 18 may be transmitted to remote system over a wired communication link (e.g., a serial communication link, such as an RS-232 serial port, a universal serial bus, or a PS/2 port) or a wireless communication link (e.g., , an infrared (IR) wireless link or a radio frequency (RF) wireless link).

### III. Exemplary Pointing Device Architecture

FIG. 2A shows a top view of an exemplary embodiment 30 of the pointing device 10 and FIG. 2B shows a cross-sectional side view of the pointing device 30 taken along the line 2B-2B. In the pointing device 30, the displaceable member is implemented by a puck 32. The puck 32 is movable within an operational zone 34 that is defined by walls of an opening defined in a support frame 36. In general, the opening defining the operational zone 34 may be any shape, including a circular shape (as shown) and a polygonal (e.g., rectangular) shape. The support frame 36 mechanically supports a restoring mechanism 38, which is implemented for illustrative purposes by a set of four springs 40. The support frame 36 is mounted on a substrate 42. The sense system 14 is supported underneath the puck 32 on the substrate 42.

In operation, the puck 32 moves in response to the application of a lateral force by the user's finger 24. When the user releases puck 32 by removing his or her finger 24, the puck 32 is returned to its centered position by the restoring mechanism 38.

In some embodiments, the processing system 16 determines from the sense signals 26 when the user has applied to the puck 32 a vertical force that exceeds a selected threshold. Based on this information, the processing system 16 determines whether the puck 32 is in an in-contact state (i.e., when the user is manipulating the puck 32) or in an out-of-contact state (i.e., when the user is not manipulating the puck 32). During the out-of-contact state, the processing system 16 sets the velocity of the cursor 24 to zero to allow the restoring mechanism 38 to re-center the puck 32 without affecting the position of the cursor 24 on the display 22. This feature is particularly desirable in laptop computers, hand-held devices and other miniature applications in which the field of motion of the puck 32 is significantly constrained.

In some embodiments, the processing system 16 additionally is able to detect when the user has applied to the puck 32 a vertical force that exceeds a second “click” threshold. Based on this information, the processing system 16 determines whether or not the puck 32 is in a “click” state, which may be correspond to a display control function that corresponds to the functions that typically are associated with the right or left buttons of a computer mouse. In this way, the user can click at the current position of the cursor 24 on the display 22 by increasing the pressure applied to the puck 32 beyond the click threshold. A mechanical click can also be engineered to provide tactile feedback for the click threshold.

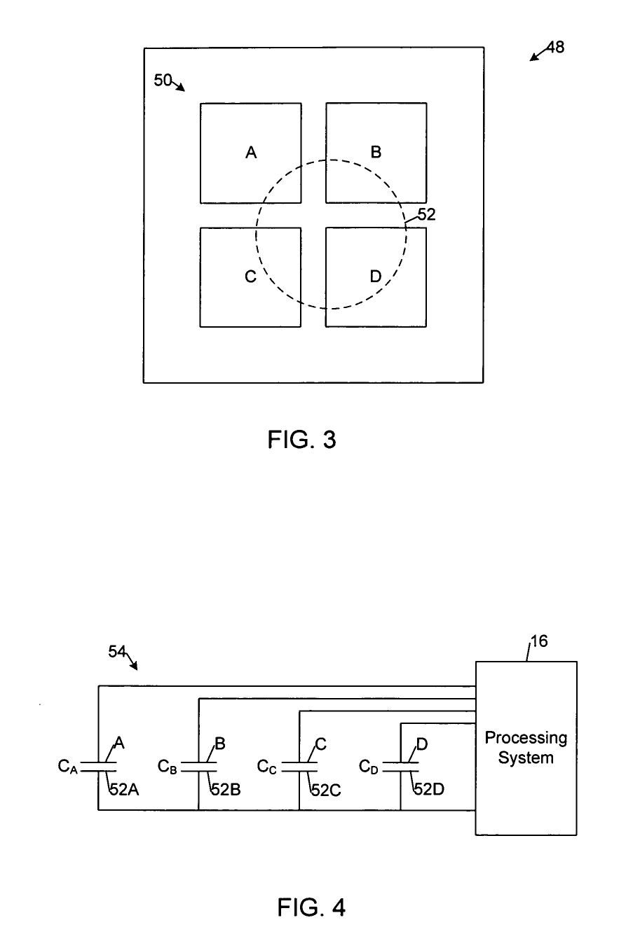

FIG. 3 shows a top view of an exemplary embodiment 48 of the pointing device 10. The pointing device 48 includes an embodiment 50 of the sense system 14 that includes four sense electrodes A, B, C, D. The sense electrodes A-D are electrically isolated from one another. Electrical connections (not shown) electrically connect the sense electrodes A-D to the processing system 16. In this embodiment, the puck 32 includes a bottom-facing puck electrode 52 (shown by the dashed circle), which may include, for example, an overlying dielectric layer that electrically insulates the puck electrode 52 from the sense electrodes A-D while allowing the puck electrode 52 to slide over the sense electrodes A-D. The amount of overlap between the puck electrode 52 and each of sense electrodes A-D depends on the position of the puck 32 in relation to the sense electrodes A-D.

FIG. 4 is a diagram of an equivalent circuit 54 of the sense system 50 that is connected electrically to the processing system 16. The respective portions of the puck electrode 52 that overlap the sense electrodes A-D form respective parallel plate capacitors having capacitances that are proportional to the corresponding overlap amounts. Since all of the capacitors share portions of the puck electrode 52, the equivalent circuit includes four capacitors C_{A}, C_{B}, C_{C}, C_{D} that are connected to the common puck electrode 52, which as respective portions identified by reference numbers 52A, 52B, 52C, 52D. In this embodiment, the processing system 16 determines the position of puck electrode 52 relative to the sense electrodes A-D by measuring the capacitances between the puck electrode 52 and each of sense electrodes A-D.

In the embodiment illustrated in FIGS. 3 and 4, the processing system 16 is connected electrically to the puck electrode 52. In other embodiments, this electrical connection is made capacitively without wires. In these other embodiments, the processing system 16 measures the amount of capacitive coupling between respective pairs of electrodes A-D. Based on the four capacitance measurements, the processing system 16 determines the respective capacitances that are associated with the four electrodes and, from this information the processing system 16 determines the position of the puck 32 in the operational zone 34.

Additional details regarding the structure and operation of the exemplary pointing device 48, which is shown in FIGS. 3 and 4, as well as descriptions of alternative embodiments of the pointing device 10 that are suitable for use in accordance with the invention, are provided in copending U.S. patent application Ser. No. 10/723,957, filed Nov. 24, 2004, by Jonah Harley et al. and entitled “Compact Pointing Device.”

### IV. Exemplary Methods Executed by Embodiments of the Pointing Device

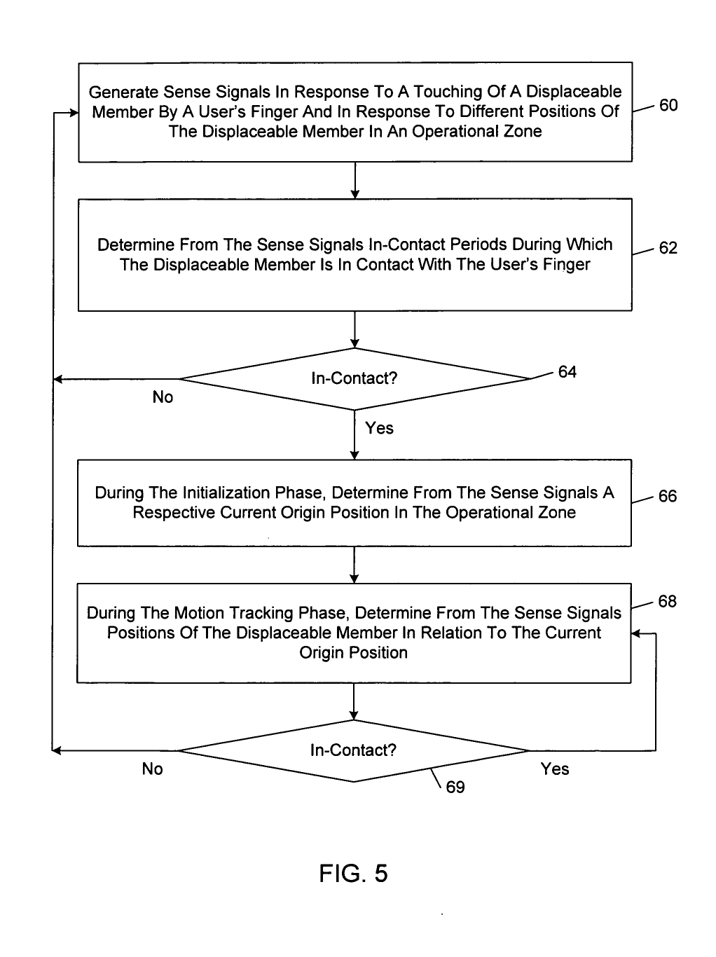

FIG. 5 shows a flow diagram of an embodiment of a method that is executed by some embodiments of the pointing device 10. This embodiment reduces cursor drift due to imperfect re-centering of the displaceable member 12 by resetting the position of the origin in one or more periods during which the user's finger 24 is determined to be in contact with the displaceable member.

In accordance with this embodiment, the sense system 14 generates the sense signals 26 in response to a touching of the displaceable member 12 by the user's finger 24 and in response to different positions of the displaceable member 12 in the operational zone (FIG. 5, block 60).

The processing system 16 determines from the sense signals in-contact periods during which the displaceable member is in contact with the user's finger 25 (FIG. 5, block 62). In some embodiments, the processing system 16 determines whether the user's finger 24 is in contact with the displaceable member 12 based on the same ones of sense signals 26 from which the processing system 16 determines the position of the displaceable member 12 in the operational zone. For example, in some implementations of the pointing device 48 shown in FIG. 3, the processing system 16 determines that the user's finger 24 is in contact with the displaceable member 12 when the magnitude of the sensed capacitances exceeds an in-contact threshold. In other embodiments, the processing system 16 determines whether the user's finger 24 is in contact with the displaceable member 12 based on different ones of sense signals 26 from which the processing system 16 determines the position of the displaceable member 12 in the operational zone. For example, in some embodiments, the pointing device 10 includes one or more pressure switches, which are responsive to the application of a downward force on the displaceable member 12. Alternatively, the pointing device 10 may include a sensor that capacitively or optically senses contact between the user's finger 24 and the displaceable member 12.

Each of the in-contact periods has an initialization phase followed by a motion tracking phase. In response to a determination that the pointing device 10 is in an in-contact period (FIG. 5, block 64), the processing system 16 performs operations including: (i) during the initialization phase, determine from the sense signals a respective current origin position in the operational zone (FIG. 5, block 66); and (ii) during the motion tracking phase, determine from the sense signals positions of the displaceable member in relation to the current origin position is (FIG. 5, block 68). The processing system 16 remains in the motion tracking phase as long as displaceable member is in contact with the user's finger 24 (FIG. 5, block 69). By resetting the current origin position during the initialization phase of an in-contact period, this embodiment is able to avoid cursor drift due to imperfect re-centering of the displaceable member 12.

As explained above, the processing system 16 uses the determined positions of the displaceable member to generate the display control signals 18.

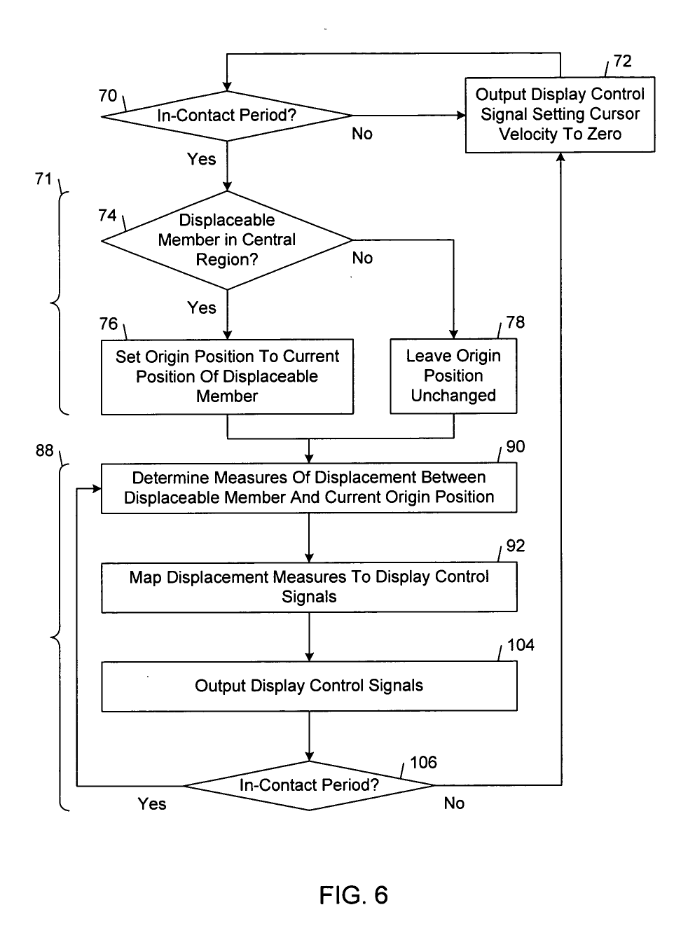

FIG. 6 shows a flow diagram of an embodiment of the method shown in FIG. 5. In accordance with this embodiment, the processing system 16 determines from the sense signals 26 whether the pointing device 10 is in an in-contact period (FIG. 6, block 70). If the pointing device 10 is not in an in-contact period (FIG. 6, block 70), the processing system 16 outputs a display control signal setting the cursor velocity to zero (FIG. 6, block 72). By setting the cursor velocity to zero when the pointing device 10 is not in an in-contact period, this embodiment is able to avoid cursor drift due to imperfect re-centering of the displaceable member 12.

If the pointing device 10 is in an in-contact period (FIG. 6, block 70), during an initialization phase 71, the processing system 16 determines from the sense signals 26 whether the displaceable member 12 is in a specified central region of the operational zone (FIG. 6, block 74). If the displaceable member 12 is within the central region (FIG. 6, block 74), the processing system 16 sets the origin position to the current position of the displaceable member 12 (FIG. 6, block 76). If the displaceable member 12 is outside the central region (FIG. 6, block 76), the processing system 16 leaves the origin position unchanged from the current origin position set during the initialization phase of a preceding one of the in-contact periods (FIG. 6, block 78). By resetting the position of the origin only when the displaceable member 12 is within the specified central region, this embodiment is able to avoid inadvertently re-setting the origin in a peripheral region of the operational zone, which would result in the zero cursor velocity position of the displaceable member 12 being defined far from the center of the operational zone.

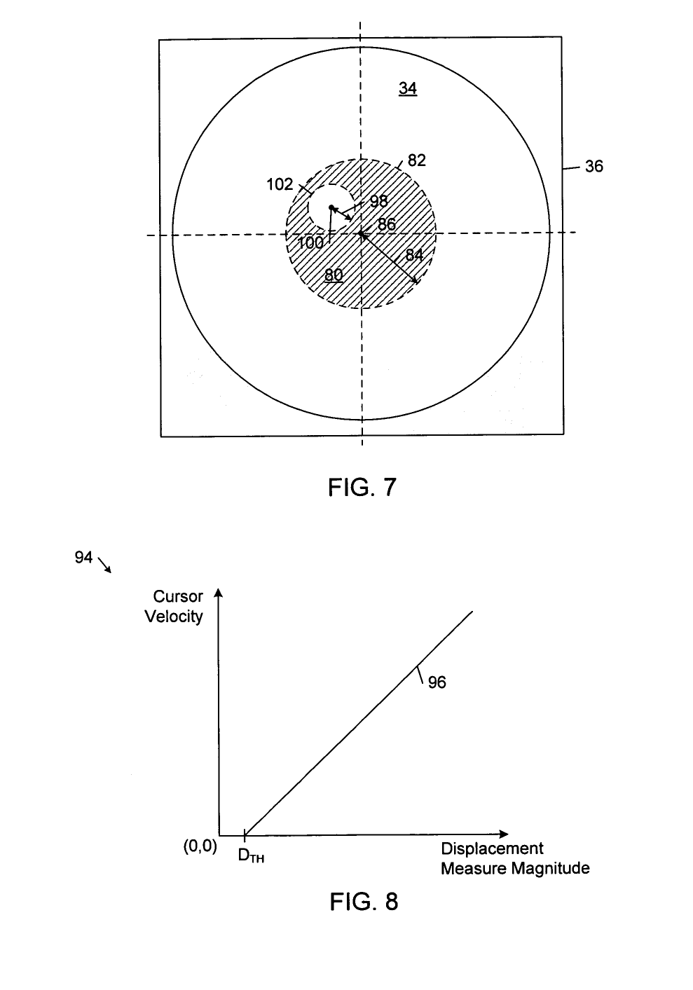

FIG. 7 shows an example of a specified central region 80 that is superimposed over a top view of the operational zone 34 of the pointing device 30 (see FIG. 7). In this embodiment, the central region 80 is a region that is defined by a circular boundary 82 that is located a fixed radial distance 84 from the center 86 of the operational zone 34. The radial distance 84 typically is set to a distance within which the displaceable member has a high likelihood of being re-centered by the restoring mechanism. In some embodiments, the central region 80 has a size that corresponds to the dead zone size in a typical displacement-type pointing device.

Referring back to FIG. 6, during a motion tracking phase 88 of an in-contact period, the processing system 16 determines from the sense signals 26 measures of displacement between the displaceable member 12 and the current origin position (FIG. 6, block 90). In some embodiments, the displacement measures correspond to a distance and direction in a coordinate system centered at the current origin position.

The processing system 16 maps the displacement measures to display control signals 18 (FIG. 6, block 92). In general, the processing system 16 may use any one of a wide variety of linear and nonlinear mappings between the displacement measures and the display control signals 18.

FIG. 8 shows an exemplary graph 94 plotting the velocity of the cursor 24 as a function of the magnitudes of the displacement measures (see FIG. 1). In this embodiment, the processing system 16 translates the displacement measure magnitudes above a threshold displacement value (D_{TH}) to cursor velocity values in accordance with a linear mapping 96. In FIG. 7, the threshold displacement value (D_{TH}) corresponds to the distance 98 from the current origin position 100. The processing system 16 maps the displacement measures below the threshold displacement value (D_{TH}) to zero cursor velocity. In this way, the threshold displacement value (D_{TH}) defines a zero cursor velocity zone 102 that is centered at the current origin position 100, as shown in FIG. 7. The presence of the zero cursor velocity zone 102 prevents the cursor 24 from moving immediately after the user touches the displaceable member 12. In this way, this embodiment avoids any undesirable cursor control problems that otherwise might result from any unintentional lateral forces that are applied by the user's finger 24 when the displaceable member initially is contacted. The distances over which such unintentional lateral forces may be applied are expected to be small relative to the is expected re-centering error distances. As a result, the threshold displacement value (D_{TH}) typically is much smaller than the radial dimension of the dead zone in typical displacement-type pointing devices. Therefore, this embodiment substantially avoids the unintuitive and confusing effects that typically are associated with transitions of the displaceable member out of the dead zones in typical displacement-type pointing devices.

Referring back to FIG. 6, after the displacement measures have been mapped to the display control signals (FIG. 6, block 92), the processing system 16 outputs the display control signals 18 (FIG. 6, block 104).

The processing system 16 determines from the sense signals 26 whether the pointing device 10 still is in an in-contact period (FIG. 6, block 106). If the pointing device 10 is in an in-contact period (FIG. 6, block 106), the processing system 16 repeats the processes of the motion tracking phase 88 (FIG. 6, blocks 90, 92, 104, 106). If the pointing device 10 is not in an in-contact period (FIG. 6, block 106), the processing system 16 outputs a display control signal setting the cursor velocity to zero (FIG. 6, block 72).

### V. Conclusion

The embodiments that are described in detail herein provide displacement type pointing devices and methods that are capable of avoiding cursor drift due to imperfect re-centering of the displaceable member while substantially reducing the unintuitive and confusing effects that oftentimes are associated with transitions of the displaceable member out of the predefined dead zones in typical displacement-type devices.

Other embodiments are within the scope of the claims.

What is claimed is:

1. A pointing device, comprising:
a displaceable member movable in an operational zone;
a sense system operable to generate sense signals in response to a touching of the displaceable member by a user's finger and in response to different positions of the displaceable member in the operational zone; and
a processing system operable to determine from the sense signals in-contact periods during which the displaceable member is in contact with the user's finger, each of the in-contact periods having an initialization phase followed by a motion tracking phase, wherein for each of the in-contact periods the processing system is operable to
during the initialization phase, determine from the sense signals a respective current origin position in the operational zone, and
during the motion tracking phase, determine from the sense signals positions of the displaceable member in relation to the current is origin position.

2. The pointing device of claim 1, wherein during the initialization phase of each of the in-contact periods, the processing system is operable to determine the positions of the displaceable member in relation to a specified central region of the operational zone.

3. The pointing device of claim 2, wherein during the initialization phase of each of the in-contact periods, the processing system is operable to determine from the sense signals a current position of the displaceable member in relation to the specified central region of the operational zone.

4. The pointing device of claim 3, wherein the processing system is operable to set the current origin position to the current position of the displaceable member in response to a determination that the determined displaceable member position is inside the specified central region of the operational zone.

5. The pointing device of claim 3, wherein, in response to a determination that the determined displaceable member position is outside the specified central region of the operational zone, the processing system is operable to leave the current origin position unchanged from the current origin position set during the initialization phase of a preceding one of the in-contact periods.

6. The pointing device of claim 1, wherein during the motion tracking phase of each of the in-contact periods the processing system determines respective measures of displacement between the positions of the displaceable member and the current origin position.

7. The pointing device of claim 6, wherein, during the motion tracking phase of each of the in-contact periods, the processing system derives display control signals from the determined displacement measures and outputs the display control signals.

8. The pointing device of claim 7, wherein, during the motion tracking phase of each of the in-contact periods, the processing system is operable to generate a display control signal setting cursor velocity to zero in response to a determination that one or more of the displacement measures are within a specified distance of the current origin position.

9. The pointing device of claim 1, wherein the processing system is operable to determine from the sense signals out-of-contact periods during which the displaceable member is out of contact with the user's finger, and during each of the out-of-contact periods the processing system outputs display control signals operable to maintain a cursor on a display in a stationary position regardless of any actual displacement between the positions of the displaceable member and the current origin position.

10. The pointing device of claim 1, further comprising a position restoring system operable to urge the displaceable member toward a central region of the operational zone.

11. A pointing device, comprising:
displaceable member means movable in an operational zone;
sensing means for generating sense signals in response to a touching of the displaceable member means by a user's finger and in response to different positions of the displaceable member means in the operational zone; and
processing system means for determining from the sense signals in-contact periods during which the displaceable member means is in contact with the user's finger, each of the in-contact periods having an initialization phase followed by a motion tracking phase, wherein for each of the in-contact periods the processing system means is operable to
during the initialization phase, determine from the sense signals a respective current origin position in the operational zone, and
during the motion tracking phase, determine from the sense signals positions of the displaceable member means in relation to the current origin position.

12. A pointing method, comprising:
generating sense signals in response to a touching of the displaceable member by a user's finger and in response to different positions of the displaceable member in an operational zone;
determining from the sense signals in-contact periods during which the displaceable member is in contact with the user's finger, each of the in-contact periods having an initialization phase followed by a motion tracking phase; and
for each of the in-contact periods
during the initialization phase, determining from the sense signals a respective current origin position in the operational zone, and
during the motion tracking phase, determining from the sense signals positions of the displaceable member in relation to the current origin position.

13. The pointing method of claim 12, wherein during the initialization phase of each of the in-contact periods, the determining comprises determining the positions of the displaceable member in relation to a specified central region of the operational zone.

14. The pointing method of claim 13, wherein during the initialization phase of each of the in-contact periods, the determining comprises determining a current position of the displaceable member from the sense signals in relation to the specified central region of the operational zone.

15. The pointing method of claim 14, further comprising setting the current origin position to the current position of the displaceable member in response to a determination that the determined displaceable member position is inside the specified central region of the operational zone.

16. The pointing method of claim 14, further comprising leaving the current origin position unchanged from the current origin position set during the initialization phase of a preceding one of the in-contact periods in response to a determination that the determined displaceable member position is outside the specified central region of the operational zone.

17. The pointing method of claim 12, further comprising determining respective measures of displacement between the positions of the displaceable member and the current origin position during the motion tracking phase of each of the in-contact periods.

18. The pointing method of claim 17, further comprising, during the motion tracking phase of each of the in-contact periods, generating a display control signal setting cursor velocity to zero in response to a determination that one or more of the displacement measures are within a specified distance of the current origin position.

19. The pointing method of claim 18, wherein the outputting comprises outputting display control signals conveying velocity parameters operable to control velocity of a cursor on a display.

20. The pointing method of claim 12, further comprising:
determining from the sense signals out-of-contact periods during which the displaceable member is out of contact with the user's finger, and
during each of the out-of-contact periods outputting display control signals operable to maintain a cursor on a display in a stationary position regardless of any actual displacement between the positions of the displaceable member and the current origin position.
